(19) United States
(12) Patent Application Publication
(10) Pub. No.: US 2005/0256898 A1
(43) Pub. Date: Nov. 17, 2005

(54) Computer system including file sharing device and a migration method

(76) Inventors: Etsutaro Akagawa, Kawasaki (JP); Hiroshi Furukawa, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/902,800

(22) Filed: Aug. 2, 2004

(30) Foreign Application Priority Data
May 7, 2004 (JP) 2004-138081

(51) Int. Cl. G06F 17/30

(52) U.S. Cl. 707/102

(57) ABSTRACT

When a file server migrates from an existing file server to a new file server, data is allowed to migrate and setting information for a file system can migrate, too. At this time, data migration timing can be arbitrarily designated while a file sharing service is executed without stop and while securing system performance. A file migration program of the new file server is connected in a block level to a volume of the existing file server to acquire file sharing configuration and volume setting information of the existing file server. During the migration of the file server, a file read/write request from the file sharing access program of the host computer is executed for the volume through the block access program of the existing file server on the basis of file sharing configuration and volume setting information of the existing file server so acquired.

### CROSS-REFERENCE TO RELATED APPLICATIONS:

The present application claims priority from Japanese application JP 2004-138081 filed on May 7, 2004, the content of which is hereby incorporated by reference into this application.

### BACKGROUND

This invention relates to a computer system having a file sharing device. More particularly, the invention relates to a computer system having a file sharing device that will be suitable for executing migration of a file sharing device by migrating volume setting information at the time of migration of a file sharing device and also migrating the file sharing device without stopping the system while securing performance during migration, too.

A quantity of data handled by a computer system has more and more enormous in recent years and a capacity of a storage device as a preservation site of the data has become greater and greater. Functions of hardware devices of file sharing devices (file servers) providing a file sharing service to a host computer used by users by use of a storage device have become higher and higher every year, too. When the quantity of the data stored increases and the functions of the devices become higher in this way, needs occur in that existing storage devices and file servers are replaced by new devices having a greater capacity and higher functions.

In migration of devices under such circumstances, migration of the data stored in the storage device is essentially necessary, too. However, the problem remains yet unsolved that migration of the data having a great capacity is time consuming and a business suspension time during data migration gets elongated by an existing method. Another problem is that migration of attribute information the file has for data management cannot be migrated by merely copying the data when migrating the file server.

To solve these problems, U.S. 2003/0110237A1 corresponding to JP-A-2003-173279 describes a method that accomplishes a substantially-non-stop data migration of a file server inclusive of file attributes.

More concretely, when a new file server is introduced into an environment in which an I/O operation is conducted first by an existing file server and a host computer, connection between the existing file server and the host computer is once cut off and then the new file server and the host computer and the new file server and the existing file server are connected to one another, respectively. When the data is migrated from the existing file server to the new file server, the data inclusive of the attribute information of the file itself are copied between the file servers. If any file access is made from the host computer during this data migration, the data is copied as ordinarily from the new file server when the file has already been migrated and is copied to the new file server from the existing file server during the access processing when the file has not yet been migrated, and the data migration processing inclusive of the file attribute is accomplished by executing an I/O processing as if the new file server transparently continued file sharing service.

### SUMMARY

Although the method described in JP-A-2003-173279 can execute the data migration of the file server inclusive of the file attribute information and the file sharing service can be succeeded to the new file server substantially on the real time basis, it will be necessary to solve the following problems: the first problem is that a load to the new file server becomes high because the new file server always processes simultaneously the file access from the host computer, and the processing may be retarded when the file access from the host computer is frequent.

Then, a setup is necessary that executes the data migration processing when the file access from the host computer is small, while keeping the operation by the data of the existing file server.

An area that stores the data to be migrated is a volume of a storage device. To attain a complete migration of the file server, set information about a file system existing inside the volume must be succeeded in addition to the file attribute information copied in the laid-open patent publication described above. An example of the set information inside the volume is Quota having a function of limiting a use quantity for each user group using the file sharing service. Since Quota is set to the file system but not to each file, the method of the laid-open patent publication described above that conducts migration in the file unit cannot cope with migration of the file server inclusive of the Quota function.

To solve the problem described above, the present invention provides a migration method of a file server that can migrate not only data but also set information for a file system when a file server is migrated from a second file server to a first file server and can arbitrarily designate a data migration timing by executing a non-stop operation of a file sharing service while securing system performance.

In a configuration of a computer system in which migration is made from a second file server to a first file server, for example, the second file server has file sharing configuration, a volume, a file stored in the volume, volume setting information of the volume, a file sharing program and a block access program for gaining access to the volume. The first file server has file sharing configuration, a file sharing program and a file migration program.

Under such a circumstance, the file migration program of the first file server is connected in a block level to the volume of the second file server and acquires the file sharing configuration and the volume setting information of the second file server.

Migration from the second file server to the fist file server is conducted by executing a file read/write request processing from the file sharing access program of the host computer through the block access program of the second file server on the basis of the file sharing configuration and the volume setting information of the second file server so acquired.

In this migration from the second file server to the first file server, the file migration program first suspends the existing file sharing program and then gains access in the block level to the volume of the second file server through the network and mounts the volume. When the volume setting information such as Quota information is stored in the volume, the setting information of the volume is acquired so that it can be used on the side of the file sharing program of the first file server.

In the actual migration of the file, the file migration program analyzes a time at which a load is low in accordance with an instruction from a manager or with performance data of the new file server, and the migration from the second file server to the first file server may be executed at an arbitrary timing by a processing similar to the one described in the laid-open patent publication described above.

Incidentally, an identification number (for example, IP (Internet Protocol) address) allocated to the interface of the second file server is as such allocated to the interface of the first file server and the migration of the file server can be transparently conducted from the host computer.

In a computer system having another configuration for executing migration from a second file server to a first file server, the second file server and a volume to which access is made from the first file server exist inside dedicated second and first storage devices, respectively, and both storage devices and both file servers are connected through a storage area network (SAN). Incidentally, the form of the network is not restrictive and the form connected by SCSI may be used, for example.

The second file sharing device has file sharing configuration and a file sharing program. The second storage device has file sharing configuration, a volume, a file stored in the volume, the volume setting information described above, access path information of the volume and an access path control program of the volume. The first file sharing device has file sharing configuration, a file sharing program and a file migration program. The first storage device has virtual volume information and a virtual volume program.

The file migration program suspends the file sharing program of the second file server and operates the virtual volume program to create virtual volume information of the first storage device for the volume of the second storage device.

An access path of a volume connecting the second file sharing device recorded to path information and the volume of the second storage device is changed to an access path of a volume connecting the first file sharing device and the virtual volume of the first storage device, and a file read/write request processing from the file sharing access program of the host computer is executed for the virtual volume of the second storage device on the basis of the file sharing configuration and the virtual volume information stored in the second storage device.

In this configuration, too, the file migration program mounts a virtual volume (volume of second storage device) allocated to the first storage device by the file sharing program of the second file server. When the volume setting information such as the Quota information is stored in the volume, the setting information of the volume is acquired and is rendered usable on the side of the sharing program of the first file server in the same way as in the configuration described above.

In this configuration, migration of only the file server is possible. Migration of only the storage device is also possible. Further, migration of both of the file server and the storage device is also possible.

According to such a configuration, the migration of management information inclusive of setting information of the file and the volume can be executed when migrating the file server. The second file server can be operated while the real data is stored in the volume used by the first file server and data migration can be made at an arbitrary timing.

Therefore, it becomes possible to reduce troubles and working steps for migration and possible setting mistakes during migration, to eventually reduce the management cost and to expand a free operation in accordance with a device introduction plan.

Other features of the invention will become apparent from the following description of the specification taken in conjunction with the accompanying drawings.

### BRIEF DESCRIPTION OF THE DRAWINGS

FIG. 1 is a structural view of a computer system for executing migration of a file server according to a first embodiment of the invention;

FIG. 2 shows an example of a table for storing file sharing configuration stored in an existing file server;

FIG. 3 shows an example of a table for storing volume setting information stored in an existing file server;

FIG. 4 shows an example of a table for storing a structure of a file stored in an old file server;

FIG. 5 is a flowchart showing a procedure of a migration processing of a file server according to the first embodiment;

FIG. 6 shows a screen for succession of an IP address from an existing file server to a new file server;

FIG. 7 is a structural view of a computer system for executing migration of a file server according to a second embodiment of the invention;

FIG. 8 shows an example of a table for storing path information 323;

FIG. 9 shows an example of a table for storing virtual volume information 316;

FIG. 10 is a flowchart showing a procedure of a migration processing of a file server according to the second embodiment;

FIG. 11 is a structural view of a computer system for executing migration of a file server according to a third embodiment of the invention; and

FIG. 12 is a structural view of a computer system for executing migration of a file server according to a fourth embodiment of the invention.

### DESCRIPTION OF THE EMBODIMENTS

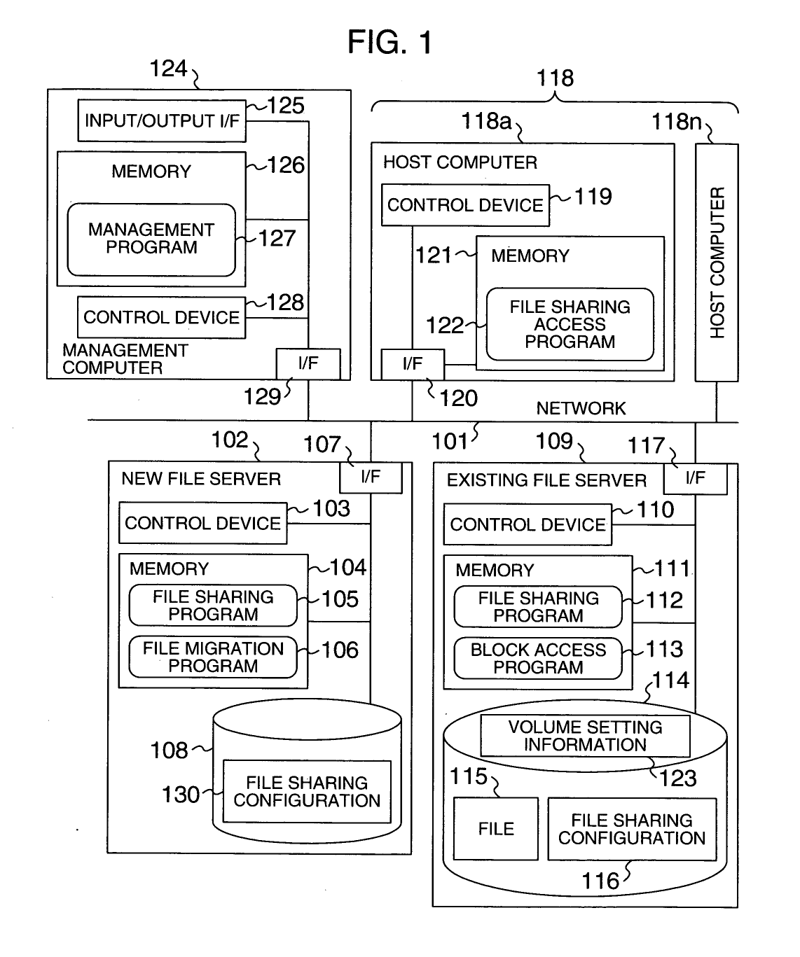

Preferred embodiments of the invention will be hereinafter explained with reference to FIGS. 1 to 12.

### First Embodiment

A first embodiment of the invention will be explained with reference to FIGS. 1 to 6.

To begin with, a configuration of a computer system for executing migration of a file server according to the first embodiment will be explained with reference to FIG. 1.

FIG. 1 is a structural view of the computer system for executing migration of the file server according to the first embodiment.

In the computer system to be explained in this embodiment, host computers 118 that are generally plural, a management computer and a file server (file sharing device; hereinafter called “file server” in the explanation of the embodiments) are connected to one another through a network 101.

It will be assumed that a system manager attempts to realize migration of a file sharing function provided by an existing file server 109 to a new file server 102.

The host computer 118 includes a control device 119, a memory 121 and an interface 117 (I/F).

When the host executes the file sharing function provided by the file server, a file sharing access program 122 is loaded to and execute by the memory 121.

The file sharing access program 122 generates a write/read request of a file to the new file server 102 and the existing file server 109 connected to the network 101, through the interface 120 and receives the result.

The control device 119 executes the program on the memory 121 and gives an instruction for I/O control.

The management computer 124 executes a management program 127 for managing the system.

The existing file server 109 includes a control device 110, a memory 111, a volume 114 and an interface 117.

During an operation, a file sharing program 112 and a block access program 113 are loaded to and executed by the memory 111.

The volume 114 stores a file 115, a file sharing configuration 116 and volume setting information 123.

The interface 117 accepts a file access request of a host computer 118 (host computers 118a to 118n) connected to the network 101 and a block access request to the volume 114.

The control device 110 executes a program on the memory 111 and gives instructions for data access of the volume 114 and for I/O control.

The file sharing program 112 is a program for sharing a file on the existing file server 109, processes a file access request of the computer 118 accepted by the interface 117, executes a write/read processing of the data to and from the file 115 on the basis of the file sharing configuration 116 and returns the processing result to the host computer 118 through the interface 117.

The block access program 113 processes the block access request accepted by the interface 117, executes the write/read processing in the volume block level for the volume 114 and returns the processing result to the accessing party through the interface 117.

The new file server 102 includes a control device 103, a memory 104, a volume 108 and an interface 107 (I/F) in the same way as the existing file server 109.

A hardware function of each part is the same as that of each part of the existing file server 109.

During the operation, the file sharing program 105 and the file migration program 106 are loaded to and executed by the memory 104.

The volume 108 stores the file sharing configuration 108. The volume 108 may further contain files and volume information. Because they are not relevant to the migration of the file server to be explained in this embodiment, however, they are not shown in FIG. 1.

The file sharing program 105 is a program for sharing a file on-the new file server 102, processes the file access request of the host computer 118 accepted by the interface 107, executes a write/read processing of the data to and from the file 115 on the basis of the file sharing configuration 108 and returns the processing result to the host computer 118 through the interface 107.

The file migration program 106 is a program for executing migration of the file server of this embodiment, and executes control of the file sharing program 112 of the existing file server 109 and the file sharing program 105 of the new file server 102, and volume access in a block level to the volume 114 of the old file server 109.

Incidentally, since the file sharing program 105 so operates as to gain access to its own volume 108 by means of the file migration program 106, it may have a function that is the same as, or different from, the function of the existing file sharing program 112.

Next, a data structure associated with migration of the file server in this embodiment will be explained.

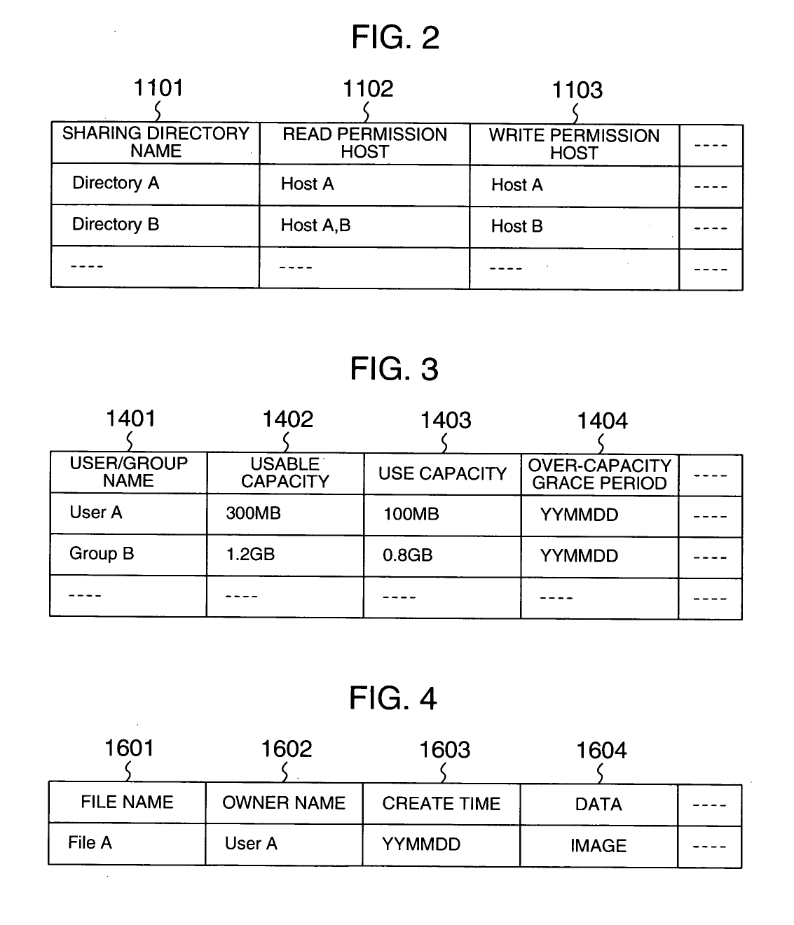

FIG. 2 show an example of a table storing file sharing configuration stored in the existing file server.

FIG. 3 show an example of a table storing volume configuration stored in the existing file server.

FIG. 4 show an example of a table storing a file structure stored in the existing file server.

As shown in FIG. 2, the table for storing the file sharing configuration 116 includes a sharing directory name field 1101, a read permission host name field 1102 and a write permission host name field 1103.

The sharing directory name field 1101 stores a name of a directory shared. In this embodiment, a directory is explained as a sharing unit but sharing may be made in a file unit. The read permission host name field 1102 stores a host name permitting read to a file belonging to the directory of the sharing directory name field 1101. The write permission host name field 1103 stores a host name permitting write to a file belonging to the directory of the sharing directory name field 1101.

The volume setting information 123 is the information that does not describe setting information in the file unit but describes setting of the entire volume. The file sharing program 112 controls the volume 114 recognized (mounted) on the basis of the volume configuration 123 shown in FIG. 1. A suitable example of the volume setting information is Quota information as a function capable of designating a size of a usable storage area for each user group. Quota is the function for designating the storage area for the entire volume.

When the volume setting information 123 is the Quota information, the table storing the volume setting information 123 includes a user group name field 1401, a maximum capacity field 1402, a use capacity field 1403 and a grace period field 1404 as shown in FIG. 3.

Incidentally, the explanation is hereby given on the case where the volume setting information 123 is the Quota information but various kinds of information may be assumable as the information relating to the volume.

The user group name field 1401 stores the user group name as the setting object of the volume. The maximum capacity field 1402 stores the maximum capacity that the object user group can use. The use capacity field 1403 stores the present use capacity of the object user group. The grace period field 1404 stores the omissible grace period that can be omitted when the use capacity of the object user group exceeds the capacity.

The file 115 includes a file name 1601, an owner name 1602, a creation time 1603 and data 1604 as shown in FIG. 4.

The file name 1601 stores the name that can be primarily identified on the file system. The owner name 1602 stores the owner of the file. The creation time 1603 stores the time at which this file is created.

The data 1604 represents the data main body of the file. In the example shown in FIG. 4, image data is stored.

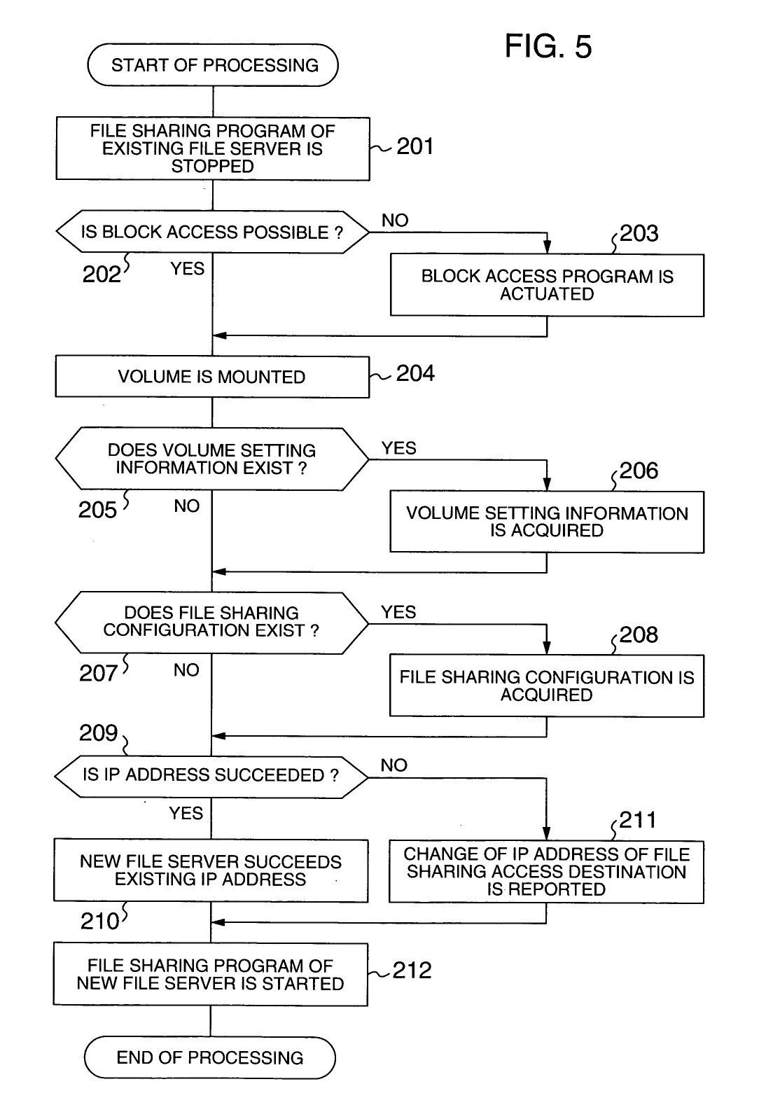

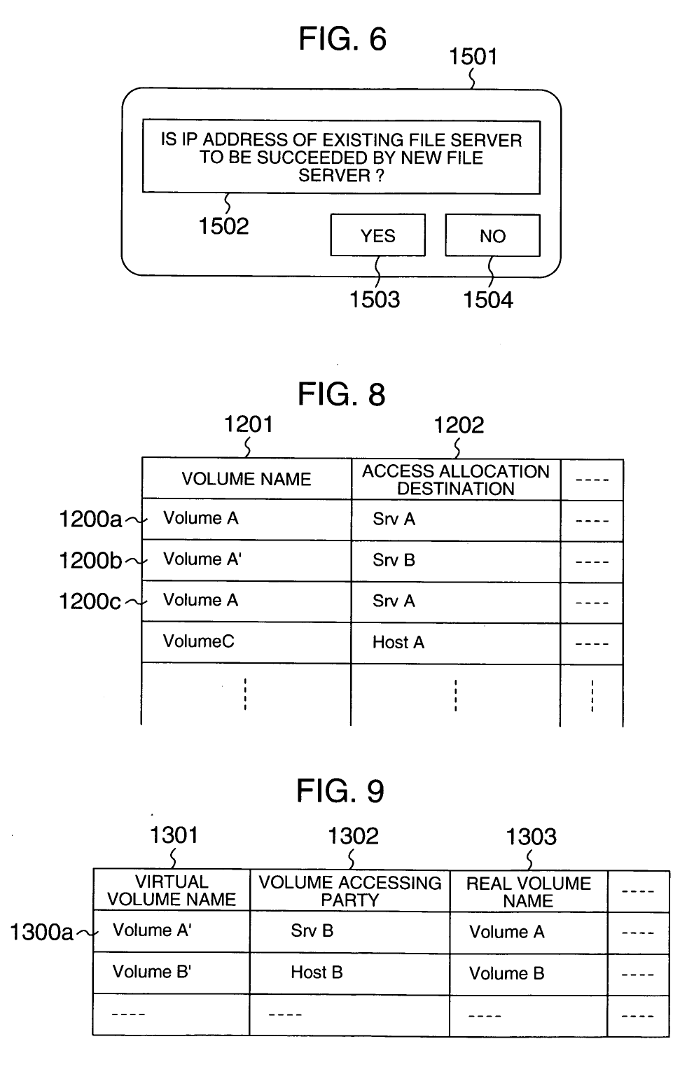

Next, the migration processing of the file server in this embodiment will be explained with reference to the flowchart shown in FIG. 5 and also to the drawings explained so far in combination with FIG. 6.

FIG. 5 is the flowchart showing the procedure of the migration processing of the file server according to the first embodiment.

FIG. 6 shows a screen for selecting succession of an IP address from the existing file server to the new file server.

Incidentally, exchange of data between the existing file server 109 and the new file server 102, acquisition of information, generation of commands, and so forth, are all executed through the network 101.

First, when the manager who wants to migrate the file sharing service from the existing file server 109 to the new file server 102 actuates the file migration program 106 by using the management program 127 from the management computer 124, the file migration program 106 suspends the file sharing program 112 of the existing file server 109 (Step 201).

Next, the file migration program 106 checks whether or not the block access program 113 of the existing file server 109 operates and judges whether or not the volume 114 of the existing file server 109 is accessible in the block level (Step 202).

When the block access program 113 does not operate in Step 202 (No in Step 202), the file migration program 106 actuates the block access program 113 so that the new file server 102 can be connected to the volume 114 in the block level and becomes accessible (Step 203).

Next, the file migration program 106 mounts the volume 114 to the new file server 102 so that the write/read processing can be executed to and from the block of the volume (Step 204).

The file migration program 106 checks whether or not volume setting information 123 for the volume 114 such as the Quota information stored in the volume 114 exists (Step 205).

When the volume setting information 123 exists in Step 205 (Yes in Step 205), the file migration program 106 acquires the volume setting information 123 (Step 206). This volume setting information 123 is looked up when the control device of the new file server 102 executes the file sharing program 105. The volume setting information 123 hereby acquired may be put on the memory 104 or may be stored in an auxiliary storage device.

Next, the file migration program 106 judges whether or not the file sharing configuration 116 stored in the volume 114 exists (Step 207).

When the file sharing configuration 116 exists in Step 207 (Yes in Step 207), the file migration program 106 acquires the file sharing configuration 116 (Step 206). This file sharing configuration 116 is looked up when the control device of the new file server 102 executes the file sharing program 105. The file sharing configuration 116 so acquired may be put on the memory 104 or may be stored in an auxiliary storage device, or the like.

Next, to migrate the file server, the manager selects whether or not the identification number (such as the IP address) allocated to the interface 117 of the existing file server 109 is to be allocated to the interface 107 (Step 209).

For this selection, the file migration program 106 displays the dialog 1501 shown in FIG. 6 to let the manager perform this selection.

When the manager clicks a button 1503 of the dialog 1501 and selects the allocation of the same IP address (Yes in Step 209), the file migration program 106 changes the IP address of the interface 117 to another one and allocates the IP address of the interface 117 to the interface 107. (Step 210).

When the IP address of the interface 117 of the existing file server 109 is allocated to the interface 107 of the new file server 102, the change of the host computer 118 is not necessary and the new file server 102 is accessed by the same IP address.

When the allocation of the same identification number is not selected (No in Step 209), on the other hand, the user or the manager is urged to change the access destination of the file sharing access program 122 of the host computer 118 (Step 211).

Finally, the file migration program 106 operates the file sharing program 105 of the new file server 102 (Step 212). As the file sharing function is provided to the host computer 118, the file sharing function provided by the existing file server 109 is succeeded by the new file server 102.

When the processing described above is executed, the file sharing function provided by the existing file server 109 can be as such executed by the new file server 102.

Incidentally, the migration from the volume 114 of the file 115 to the volume 108 can be realized from the existing file server 109 to the new file server 102 by utilizing the technology described in the laid-open patent publication mentioned already.

In the migration of the file server described above, the explanation has been made on the assumption that the existing file server 109 and the new file server 102 have already been designated. However, it is also possible for the manager to input the IP addresses of both existing and new file servers 109 and 102 from the management computer 124, to designate the existing and new file servers 109 and 102 and to change the IP address of the new file server 102 to the IP address of the existing file server 109 by executing the processing described above.

In the file server migration method according to this embodiment, the manager can arbitrary designate and monitor the timing at which the migration of the file is made, by monitoring and analyzing load performance information of the new file server and conducting the migration when a processing load is below a predetermined value, for example. Since the new file server 102 provides the file sharing function to its file 115 while leaving the file 115 in the existing file server 109 in this embodiment, the migration of the file 115 to the new file server 102 can be conducted at an arbitrary timing.

Incidentally, the file migration program 106 on the new file server 102 executes the processing in the method of this embodiment. However, the manager may execute serially and manually the processing content but the file migration program 106 need not always be put on the new file server 102. For example, the file migration program 106 may be put on a dedicated management computer 124 for managing each device and may execute this processing.

In the configuration of this embodiment, further, when a cluster system is constituted by using the new file server 102 and the existing file server 109 and the write access and the read access to and from the volume are shared by the respective file sharing programs 105 and 112, the migration for sharing the file can be conducted without suspending the file sharing access from the host computer 118.

According to the embodiment described above, it is possible to execute the migration of the file and set information of the volume associated with the file by the file migration program. The new file server can be operated and migration of the file can be conducted at an arbitrary timing while the volume used in the existing file server is kept reserved.

### Second Embodiment

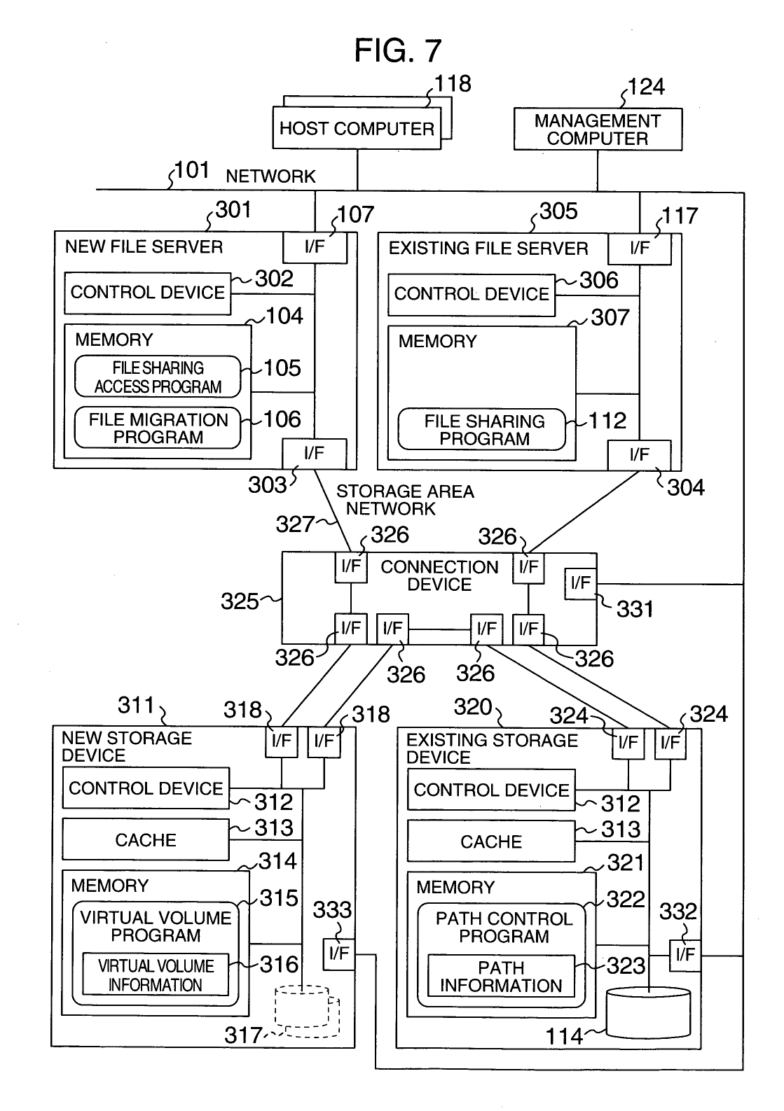

The second embodiment will be explained with reference to FIGS. 7 to 10.

First, a configuration of a computer system for executing the migration of a file server will be explained with reference to FIG. 7.

FIG. 7 is a structural view of the computer system for executing the migration of the file server according to the second embodiment.

The volume exists inside the file server in the first embodiment but in this embodiment, the volume is arranged on an external storage device and the file server and the external storage device or the external storage devices are connected to one another by a storage area network through a connection device.

This embodiment is based on the assumption that the migration is made from the existing file server 305 to the new file server 301 and from the existing storage device 320 to the new storage-device 311 as the external storage device.

This external storage device accommodates a hard disk drive device called a “disk array device” or an “RAID device” and can store the data. As shown in FIG. 1, the existing file server 305, the new file server 301, the existing storage device 320 and the new storage device 311 are connected to one another through the respective interfaces and through the storage area network 327. The storage area network 327 can utilize a connection form such as a Fibre Channel and CSI. The connection device 325 is a switch as a device having a switching function, for example.

The network 101 is a network through which the managing computer 124 manages each device.

The existing file server 109 includes a control device 306, a memory 307, an interface 117 and an interface 304. The new file server 301 includes a control device 302, a memory 104, an interface 107 and an interface 303. These file servers are different from the file servers of the first embodiment in that they do not have the volume but have an interface 304 for a storage area network 304.

The operation of the file sharing program 106 is different, too, and the detail will be explained later in detail.

The existing storage device 320 includes a control device 312, a cache 313, a memory 321, a volume 114, an interface 324 and an interface 332.

The control device 312 controls each part of the existing storage device 320 and gives commands. The cache 313 is a high speed memory for buffering disk access. The volume 114 has volume information, file sharing configuration and a file in the same way as the volume of the first embodiment, though it is omitted from FIG. 3.

The interface 324 is an interface that accepts the block access of the volume through the storage area network. The interface 332 is an interface that accepts an instruction and control from the management computer 124 through the network 101.

A path control program 321 is loaded to and executed by the memory 321. A path control program 322 is a program for gaining access to the volume on the basis of path information 323. The accessing party of the volume may be the new file server 301, the existing file server 305, the host computer 118 and other storage devices.

The new storage device 311 has hardware-wise the same configuration as the existing storage device 320 and includes a control device 312, a cache 313, a memory 321, a volume 317, an interface 318 and an interface 333. The volume includes the file sharing configuration though it is omitted in the drawing.

A virtual volume program 315 is loaded to and executed by the memory 314. The virtual volume program 315 virtualizes the volume (logical volume and physical volume) and makes it possible to gain access to the data as the virtual volume. A real volume contains both logical volume and physical volume. The virtual volume is a volume to which the host computer can make access through the network and the real data is written into the real volume. When the virtual volume is defined, a plurality of volumes may correspond to one virtual volume or a plurality of virtual volumes may correspond to one volume.

Next, the data structure associated with the migration of the file server in this embodiment will be explained.

FIG. 8 shows an example of a table for storing the path information 323.

FIG. 9 shows an example of a table for storing the virtual volume information 316.

As described above, the path information 323 is information for gaining access to the volume. The table for accommodating the path information 323 includes a volume name field 1201, an access allocation destination field 1202, and so forth.

The volume name filed 1201 stores a name representing the real volume or the virtual volume. The access allocation destination field 1202 is a device allocated to gain access to the volume and stores identifiers such as a file server, a storage device, and so forth.

In the record 1200a, for example, the access allocation destination is “SrvA” and a path for gaining access is extended to the real volume “Volume A”.

The virtual volume information 316 is the information for associating the real volume with the virtual volume as described above. The table for storing the virtual volume information 316 has a virtual volume name field 1301, a volume accessing party field 1302 and a real volume name filed 1303.

Names of a corresponding virtual volume and a corresponding real volume are put into the virtual volume name field 1301 and the real volume name field 1303, respectively. A name of the device to be accessed as the virtual volume is put into the volume accessing party field 1302.

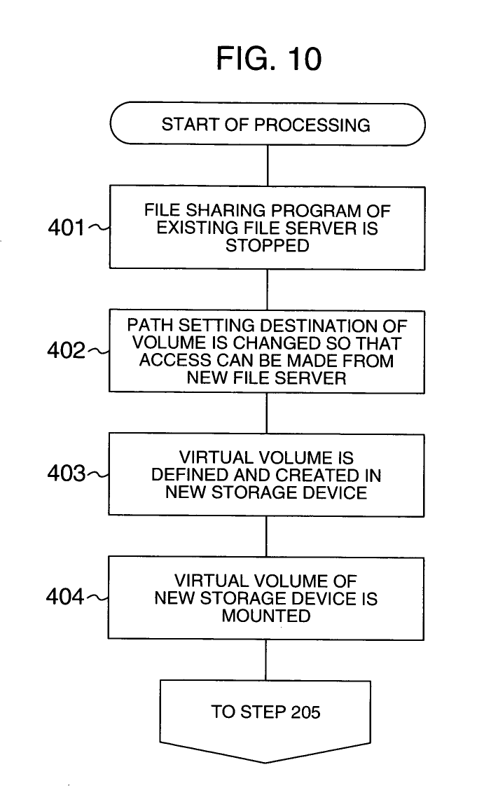

Next, the migration processing of the file server according to this embodiment will be explained with reference to the flowchart of FIG. 10 and also to FIGS. 7 to 9 explained already.

FIG. 10 is a flowchart showing the procedure of the migration processing of the file server according to the second embodiment.

In this embodiment, the file server and the storage device having the volume are connected as shown in FIG. 7 and the access at the time of the migration of the file server is conducted by changing the path information.

First, when the manager who wants to migrate the file sharing service from the existing file server 305 to the new file server 301 operates the file migration program 106, the file migration program 106 suspends the file sharing program 112 of the exiting file server 109 (Step 401).

Next, the file migration program 106 changes the setting destination of the path extended to the volume 114 from the existing file server 305 so that the access can be made from the new file server 301.

The change of the path information will be concretely explained below.

It will be assumed that the exiting file server 305 is “SrvA”, the new file server 301 is “SrvB” and the new storage device 311 is “StrB”. It will also be assumed that the access path is extended from “SrvA” to the real volume “Volume A” in the existing storage device 320 as in the record 1200a shown in FIG. 8.

When the setting destination of the path is changed, the record 1200a is rendered invalid and access is to be made on the basis of the record 1200b and the record 1200c. In other words, the access path is extended by the record 1200b to “SrvB” as the new file server 301 and to the virtual volume “Volume A′” and the access path is extended by the record 1200c to “StrB” as the new storage device 311 and to the real volume “Volume A”. Needless to say, the virtual volume “Volume A′” and the real volume “Volume A” are associated by the table for storing the virtual volume information 316 shown in FIG. 9.

Consequently, when access is made from “SrvB” as the new file server 301 to the virtual volume “Volume A′”, access can be made in practice to the real volume “Volume A” in the existing storage device 320.

Next, the file migration program 106 generates and defines the virtual volume on the new storage device 311 (Step 403). In the embodiment described above, the virtual volume “Volume A′” corresponding to the real volume “Volume A” is generated and defined.

More concretely, this operation may be conducted by setting “Volume A′” to the virtual volume name field 1301, “Volume A” to the real volume name field 1303 and “Srv B” of the new file server 301 to the volume accessing party field 1302 as in the case of the record 1300a of FIG. 9 for storing the virtual volume information 316.

The file migration program 106 mounts the virtual volume on the new storage device 311 generated (Step 404). In other words, the virtual volume having the virtual volume name “Volume A′” is mounted in this example.

The subsequent procedure is the same as the procedure after Step 205 in the flowchart of FIG. 5 in the first embodiment.

The file migration from the existing file server 305 to the new file server 301 can be made by employing the processing and the configuration described above.

Incidentally, the migration of the file 115 from the volume 114 to the volume 108 can be turned to the migration from the existing file server 305 to the new file server 301 by utilizing the technology disclosed in the afore-mentioned laid-open patent publication in the same way as in the first embodiment.

However, the manager can arbitrary designate and set the timing of file migration by monitoring and analyzing load performance information on the new storage device 311 and moving when the processing load is below a predetermined value in the same way as in the first embodiment.

This is because the access is made from the file server 301 by changing the path information while the file is kept put on the volume of the existing storage device 320.

In the configuration of this embodiment, the file sharing migration can be made without suspending the access of file sharing from the host computer 118 when a cluster system is constituted by the new file server 301, the new storage device 311, the existing file server 305 and the existing storage device 320 and the write/read access to the volume is shared by the respective file sharing programs 106 and 112.

In the embodiment explained above, the new file server 301 and the new storage device 311 and the existing file server 305 and the existing storage device 320 respectively form the pairs and simultaneously execute the migration of the file server and the storage device in the pairs. However, migration of only the file server and migration of only the storage device can be individually made depending on the combination of the path information.

In this embodiment, too, migration of the file and migration of the set information of the volume associated with the file can be made by the file migration program in the same way as in the first embodiment.

In comparison with the first embodiment, migration of the volume remaining in the existing storage device 320 is made from the new file server 301 by changing the path information but the file migration can be made at an arbitrary timing by operating the new file server while the real file is kept preserved in the volume used by the existing file server in the same way as in the first embodiment.

### Third Embodiment

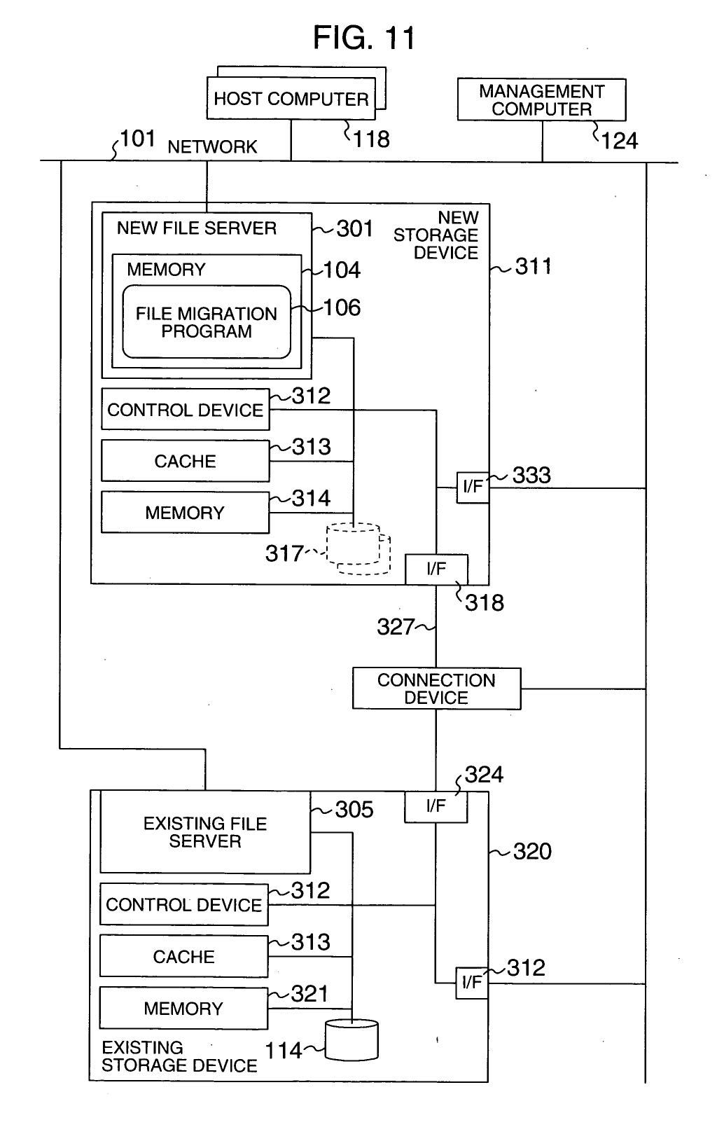

A third embodiment of the invention will be explained with reference to FIG. 11.

FIG. 11 is a structural view of a computer system for conducting file server migration according to the third embodiment.

This embodiment can be said as a modified embodiment of the second embodiment.

The storage device of this embodiment has a file server function. In other words, a new file server 301 is incorporated in a new storage device 311 and an existing file server 305 is incorporated in an existing storage device 320. A file sharing program 106 is loaded to a memory 104 in the new file server 104 and the migration of the file server and the storage device can be made by the same procedure as that of the second embodiment.

### Embodiment 4

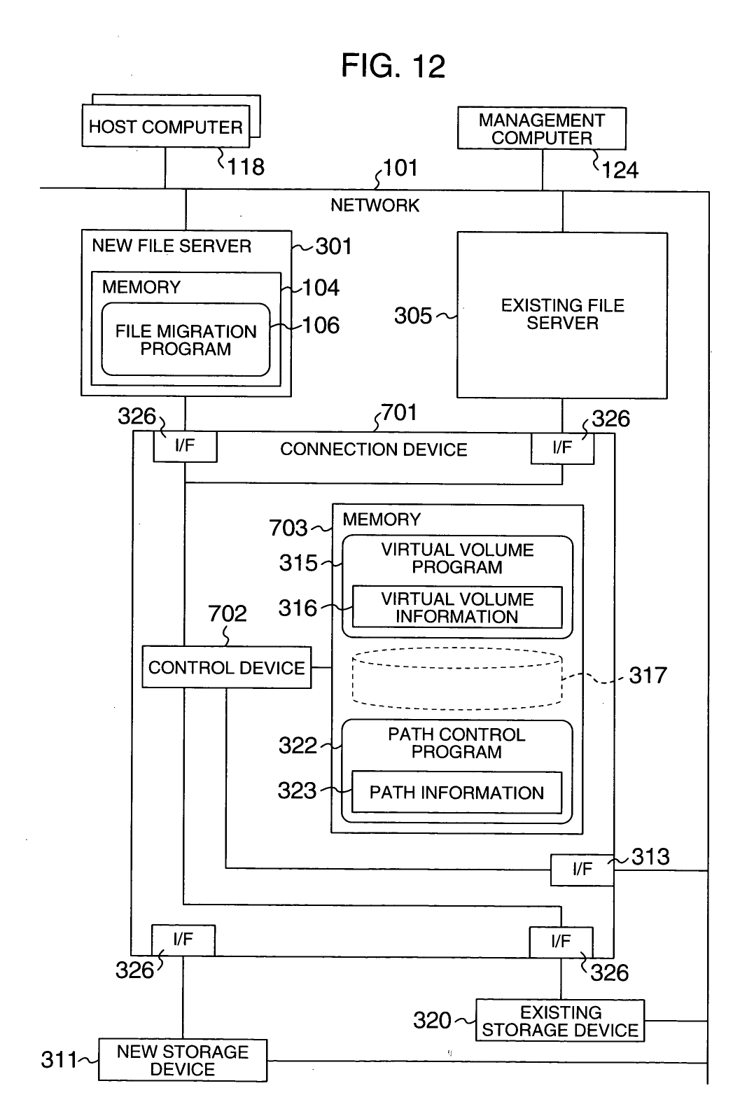

A fourth embodiment of the invention will be explained hereinafter with reference to FIG. 12.

FIG. 12 is a structural view of a computer system for executing migration of the file server according to the fourth embodiment.

This embodiment can be said as a modified example of the second embodiment, too.

A connection device 701 in this embodiment includes therein the virtual volume program 315 and the virtual volume information 316 provided to the new storage device 311 of the second embodiment and the path control program 322 and the path information 323 that are provided to the existing storage device 320, and loads and execute these programs and information to and on a memory 703.

Consequently, even ordinary storage devices can easily conduct the migration of the file and the storage device by merely preparing and connecting the connection device 701.

When the file server is migrated from the existing file server to the new file server, the invention provides a migration method of a file server that can migrate the data and the setting information to the file system and can arbitrarily designate the data migration timing while executing the file sharing service without suspending and while securing system performance.

It should be further understood by those skilled in the art that although the foregoing description has been made on embodiments of the invention, the invention is not limited thereto and various changes and modifications may be made without departing from the spirit of the invention and the scope of the appended claims.

1. A computer system having file servers connected to one or more host computers and accessed, comprising:
a first file server; and
a second file server; wherein
said second file server has a volume; and wherein:
said first file server is connected in a block level to the volume of said second file server, acquires file sharing configuration of said second file server and executes a read/write request from said host computer for the volume of said second file server on the basis of said file sharing configuration.

2. A computer system according to claim 1, wherein said second file server has volume setting information, and wherein said first file server acquires the volume setting Information of said second file server, and executes a file read/write request from said host computer for the volume of said second file sharing server.

3. A computer system according to claim 1, wherein the volume setting information of said second file server includes at least Quota information.

4. A computer system according to claim 1, wherein a file existing in the volume of said second file server is migrated at an arbitrary timing to said first file server irrespective of a read/write request from said host computer.

5. A computer system having file servers and a storage system connected to one or more host computers and accessed, comprising:
a first storage device;
a first file server for gaining access to said first storage device;
a second storage device; and
a second file server for gaining access to a file of said second storage device;
said second storage device and said second file server, and said first storage device and said first file server being connected to each other, respectively;
wherein:
said first file sharing server includes:
means for defining and generating a volume of said second storage device as a virtual volume of said first storage device;
means for changing an access path of a volume connecting said second file server to the volume of said second storage device to an access path of a volume connecting said first file server to the virtual volume of said first storage device;
means for acquiring file sharing configuration of said second file storage device; and
means for executing a file read/write request from said host computer for the virtual volume of said first storage device on the basis of the file sharing configuration of said second storage device.

6. A computer system according to claim 5, wherein the volume setting information of said second storage device includes at least Quota information.

7. A computer system according to claim 6, comprising:
a connection device;
said file servers and said storage devices being connected through said connection device;
wherein said connection device comprises:
definition generation means for defining and generating a volume as a virtual volume; and
means for setting and changing an access path of a volume connecting said storage device and said file server.

8. A migration method of a file server executed in a computer system including file servers connected to one or more host computer and accessed, for migrating a file from a second file server to a first file server sharing the file in place of said second file server said method comprising:
causing said first file server to be connected in a block level to a volume of said second file server;
causing said first file server to acquire file sharing information of said second file server; and
executing a file read/write request from said host computer for the volume of said second file server on the basis of file sharing configuration of said second file server.

9. A migration method of a file server according to claim 8, wherein said second file server has volume setting information, and said method comprises:
causing said first file server to acquire volume setting information of said second file server; and
executing a file read/write request from said host computer for the volume of said second file server on the basis of file sharing configuration of said second file server.

10. A migration method of a file server according to claim 9, wherein the volume setting information of said second file server includes at least Quota information.

11. A migration method of a file server executed in a computer system including a first file server and a second file server each being connected to one or more host computer and accessed, said method comprising:
suspending a file sharing program of said second server;
causing said first file server to be connected in a block level to a volume of said second file server;
actuating a file sharing program of said first file server;
causing said file sharing program of said first file server to acquire file sharing configuration of said second file server: and
causing said file sharing program of said first file server to execute a file read/write request from said host computer for the volume of said second file server on the basis of file sharing configuration of said second file server.

12. A migration method of a file server executed in a computer system including a first file server and a second file server each being connected to one or more host computer and accessed, said method comprising:
causing said first file server to define and generate a volume of said second storage device as a virtual volume of said first storage device;
changing an access path of a volume connecting said second file server and the volume of said second storage device to an access path connecting said first file server and a virtual volume of said first storage device;
acquiring file sharing configuration stored in said second storage device; and
executing a file read/write request from said host computer for the virtual volume of said first storage device on the basis of the file sharing configuration stored In said second storage device.

13. A storage medium storing a file migration program executed In a computer system including a first file server and a second file server connected to one or more host computers and accessed, said storage medium comprising:
suspending a file sharing program of said second file server;
connecting said file server in a block level to a volume of said second file server;
actuating said file sharing program of said first file server;
acquiring file sharing configuration of said second file server; and
causing the file sharing program of said first file server to execute a file read/write request from said host computer for the volume of said second file server on the basis of the file sharing configuration of said second file server.

14. A computer system comprising:
a management computer Including a control device, a memory to which a management program is loaded and an interface connected to a network;
a host computer including a control device, a memory and an interface connected to a network, and being loaded by a file sharing access program;
a first file server connected to one or more of said host computer and accessed, and including a control device, a memory to which a file sharing program is loaded, an interface connected to a network, and a volume for storing file sharing configuration;
a second file server including a control device, a file sharing program, a memory to which a block access program for gaining access to said volume is loaded, an interface connected to a network, a file and a volume for storing volume setting information of a volume inclusive of Quota information and a volume for storing file sharing configuration;
wherein:
said first file server receives an instruction from said management computer through the network, transmits an instruction for suspending the file sharing program of said second file server to said second file server through said network, mounts the volume to the volume of said second file server and acquires the file sharing configuration and the volume setting Information of said second file server through said network;
said first file server reports a changed IP address to a file sharing destination when an IP address of said first file server is changed,
said first file server starts the file sharing program of said first file server; and
said first file server executes a file read/write request from the file sharing access program of said host computer for the volume through a block access program of said second file server on the basis of the file sharing configuration and the volume setting information of said second file server.
